(19) United States
(12) Patent Application Publication
(10) Pub. No.: US 2023/0373616 A1
(43) Pub. Date: Nov. 23, 2023

(54) PROPELLER GUARD, FLYING BODY, AND ROD-SHAPED BODY

(71) Applicant: NIPPON TELEGRAPH AND TELEPHONE CORPORATION, Tokyo (JP)

(72) Inventors: Daisuke UCHIBORI, Tokyo (JP); Yujin HAMANO, Tokyo (JP); Kazuaki WATANABE, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/029,083

(22) PCT Filed: Sep. 30, 2020
(86) PCT No.: PCT/JP2020/037375

§ 371 Date: Mar. 28, 2023

(51) Int. Cl. B64C 27/20; B64C 27/08; B64C 27/00

(52) U.S. Cl. CPC B64C 27/20; B64C 27/08; B64C 27/006

(57) ABSTRACT

A propeller guard 2 includes: a propeller guard body 10 configured to surround a propeller 30 of a flight vehicle 20; and a rod-shaped body 40 provided on an upper portion of the propeller guard body 10 and including a first end 44 and a second end 41, in which the first end 44 of the rod-shaped body 40 is provided near a peripheral portion of an upper surface of the propeller guard body 10, and the rod-shaped body 40 extends while passing above the upper surface of the propeller guard body 10 as viewed from vertically above.

### TECHNICAL FIELD

The present disclosure relates to a propeller guard that protects a propeller of a flight vehicle, a flight vehicle, and a rod-shaped body.

### BACKGROUND ART

In recent years, a flight vehicle (for example, a drone, a multicopter, or the like) that flies by rotation of a plurality of propellers may be used for inspection of an infrastructure structure.

In Non Patent Literature 1, a method is disclosed of using a flight vehicle for inspection of pipeline facilities buried in the ground. When the flight vehicle flies in such a space surrounded by a wall surface, if the airframe collides with an object such as the wall surface, the propeller may be damaged and the airframe may crash. Thus, a propeller guard that protects the propeller may be attached to the airframe.

In Non Patent Literature 2, a propeller guard is devised for protecting a propeller when a flight vehicle collides with an object and preventing the flight vehicle from losing a flight balance and becoming uncontrollable even when the flight vehicle collides with the object.

### CITATION LIST

### Non Patent Literature

Non Patent Literature 1: Yoshihiko Yato et al., “Development of drone capable of coping with closed space such as sewer pipeline”, 29th Trenchless Technology Conference, 2.1, 2018
Non Patent Literature 2: Noriyuki Kanehira et al., “Development of a Drone Bridge Inspection System”, Kawada Technical Report, vol. 38, 2019

### SUMMARY OF INVENTION

### Technical Problem

However, when the flight vehicle moves in the vertical direction in a space surrounded by a wall surface, in the propeller guard devised in Non Patent Literature 2, there is a possibility that the guard frame comes into contact with the wall surface or the like and the flight vehicle cannot move, or the flight vehicle loses its balance and falls.

FIG. 13 is a cross-sectional view of a manhole. As illustrated in FIG. 13, in a manhole 50, when a manhole lid installed on the ground is opened and closed, a columnar or quadrangular prism structure 51 extends in the vertical direction in the ground, and a step 52 for a worker to go down to the underground or to go up to the ground is installed in the middle. The structure 51 is, for example, a reinforced concrete pipe. A manhole lid receiving frame 53 is provided near the road surface of the manhole 50.

FIG. 14 is a diagram illustrating a problem in a case where a flight vehicle with a propeller guard moves in a space surrounded by a wall surface, such as the manhole 50. As illustrated in FIG. 14, when a flight vehicle 100 to which a propeller guard is attached is caused to ascend in the structure 51, the propeller guard may be caught by the wall surface or the like of the structure 51. In this case, there is a possibility that the flight vehicle 100 rotates in an R direction with a contact point P1 between the propeller guard and the wall surface of the structure 51 as a fulcrum, and loses its flight balance and falls. Further, the flight vehicle 100 sucks air from above the propeller and discharges the air downward to float the airframe in the air. For that reason, when flight vehicle 100 rotates in the R direction (toward the wall surface of structure 51), the propeller sucks air from above thereof, whereby there is a possibility that the flight vehicle 100 stick to the wall surface of the structure 51.

An object of the present disclosure made in view of such circumstances is to provide a propeller guard, a repulsive member, and a flight vehicle capable of suppressing occurrence of rotation of the flight vehicle due to contact with an object.

### Solution to Problem

A propeller guard according to an embodiment includes: a propeller guard body configured to surround a propeller of a flight vehicle; and a rod-shaped body provided on an upper portion of the propeller guard body and including a first end and a second end, in which the first end of the rod-shaped body is provided near a peripheral portion of an upper surface of the propeller guard body, and the rod-shaped body extends while passing above the upper surface of the propeller guard body as viewed from vertically above.

A flight vehicle according to an embodiment includes a rod-shaped body provided on an upper portion of the flight vehicle, in which one end of the rod-shaped body is provided near a peripheral portion of an upper surface of the flight vehicle, and the rod-shaped body extends while passing above the upper surface of the flight vehicle as viewed from vertically above.

A rod-shaped body according to an embodiment includes one end attached to a vicinity of a peripheral portion of an upper surface of a flight vehicle or a vicinity of a peripheral portion of an upper surface of a propeller guard body configured to surround a propeller of the flight vehicle such that the rod-shaped body extends while passing above the upper surface of the flight vehicle as viewed from vertically above.

### Advantageous Effects of Invention

According to the present disclosure, it is possible to provide a propeller guard, a repulsive member, and a flight vehicle capable of suppressing occurrence of rotation of the flight vehicle due to contact with an object.

### BRIEF DESCRIPTION OF DRAWINGS

FIG. 1 is an example of a perspective view of a flight vehicle including a propeller guard according to an embodiment.

FIG. 2 is an example of a side view of the flight vehicle including the propeller guard according to the embodiment.

FIG. 3 is a diagram illustrating a state in which the flight vehicle including the propeller guard according to the embodiment comes into contact with a wall surface during movement vertically upward.

FIG. 4 is an example of a top view of a flight vehicle including a propeller guard including one rod-shaped body.

FIG. 5A is an example of a top view of a flight vehicle including a propeller guard including two rod-shaped bodies.

FIG. 5B is an example of a side view of the flight vehicle including the propeller guard including the two rod-shaped bodies.

FIG. 6A is an example of a perspective view of a flight vehicle including a propeller guard including three rod-shaped bodies.

FIG. 6B is an example of a top view of the flight vehicle including the propeller guard including the three rod-shaped bodies.

FIG. 7A is an example of a side view of the flight vehicle including the propeller guard according to the embodiment.

FIG. 7B is an example of a side view of the flight vehicle including the propeller guard according to the embodiment.

FIG. 7C is an example of a side view of the flight vehicle including the propeller guard according to the embodiment.

FIG. 8A is an example of a top view of the propeller guard according to the embodiment.

FIG. 8B is an example of a top view of the propeller guard according to the embodiment.

FIG. 9 is an example of a top view of the propeller guard according to the embodiment.

FIG. 10 is an example of a perspective view of a flight vehicle including a propeller guard including a rod-shaped body provided with a rotating member.

FIG. 11A is a diagram illustrating an example of the rotating member.

FIG. 11B is a diagram illustrating an example of the rotating member.

FIG. 12 is a diagram illustrating a state in which the flight vehicle including the propeller guard according to the embodiment comes into contact with a wall surface during movement vertically upward.

FIG. 13 is an example of a cross-sectional view of a manhole.

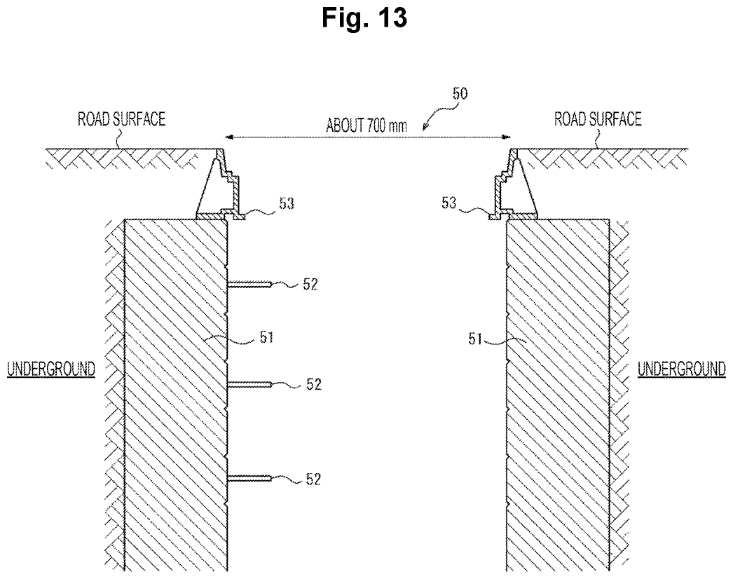

FIG. 14 is a diagram illustrating a problem of a flight vehicle with a conventional propeller guard.

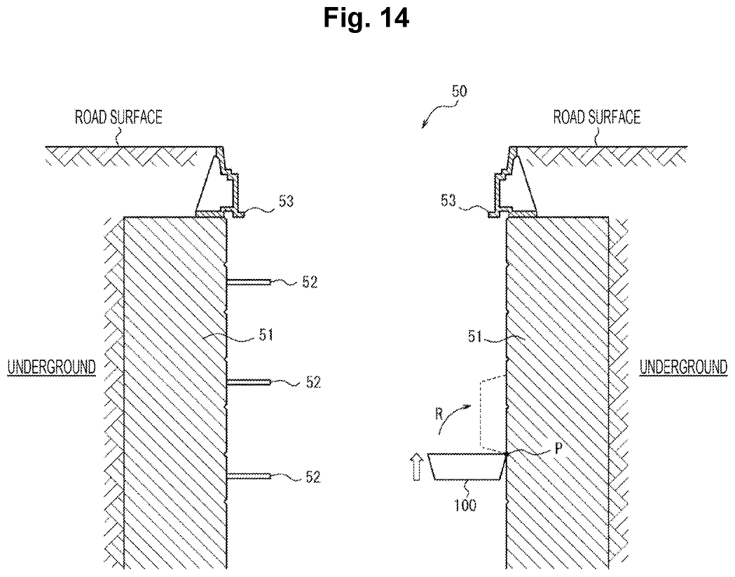

### DESCRIPTION OF EMBODIMENTS

Hereinafter, an embodiment will be described in detail with reference to the drawings. Note that the drawings are only schematically illustrated to the extent that the present invention can be sufficiently understood. Thus, the present invention is not limited only to the illustrated examples. In addition, for convenience of illustration, scales in the drawings may be different from actual scales, or may not match between the drawings.

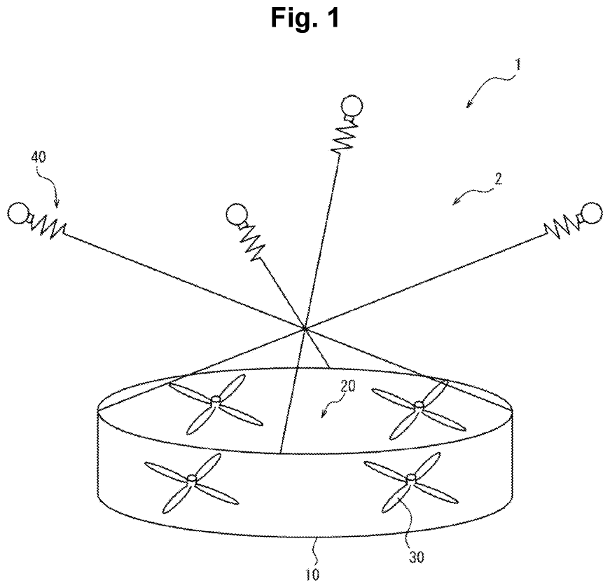

FIG. 1 is an example of a perspective view of a flight vehicle including a propeller guard according to an embodiment. A flight vehicle with a propeller guard (Hereinafter, it is simply referred to as a “flight vehicle”.) 1 illustrated in FIG. 1 includes a propeller guard body 10, a flight vehicle body 20, one or more propellers 30, and a rod-shaped body 40. Among them, the propeller guard body 10 and the rod-shaped body 40 constitute a propeller guard 2. The flight vehicle 1 flies by the one or more propellers 30 each having a vertical rotation axis.

The propeller guard body 10 is configured to surround the propellers 30, and protects the propellers 30. The propeller guard body 10 may be configured to surround not only the propellers 30 but also a whole of the flight vehicle body 20, or may be configured to surround a part of the flight vehicle body 20. The following drawings illustrate the propeller guard body 10 surrounding the whole of the flight vehicle body 20.

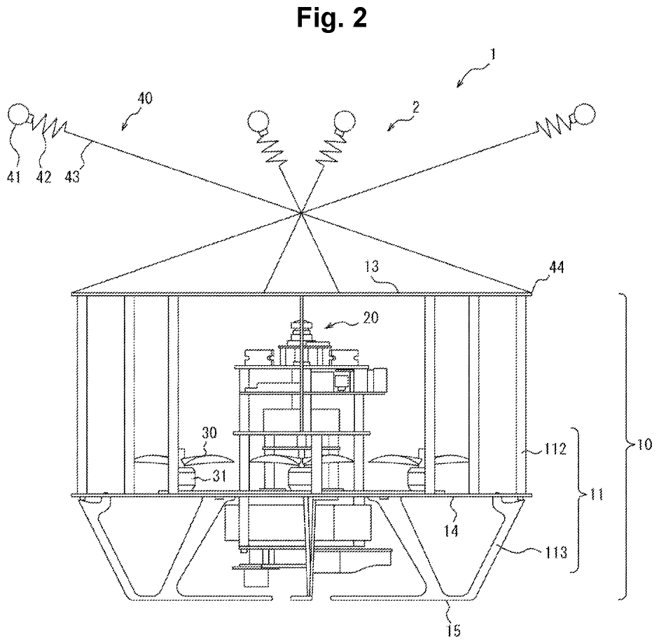

FIG. 2 is an example of a side view of the flight vehicle 1 including the propeller guard 2 according to the embodiment. The propeller guard 2 includes the propeller guard body 10 and the rod-shaped body 40. In the example illustrated in FIG. 2, the propeller guard body 10 includes a coupling frame 11, an upper frame 13, a lower frame 14, and a base frame 15. The number of coupling frames 11 is not limited to one, and can be arbitrarily determined. Note that an intermediate frame parallel to the upper frame 13 and the lower frame 14 may be further provided between the upper frame 13 and the lower frame 14. Whether or not to provide the intermediate frame and the number of the coupling frames 11 and the intermediate frames affect strength of the propeller guard body 10 when the flight vehicle 1 comes into contact with an object. Thus, for example, in a case where it is assumed that the flight vehicle 1 is moved at a high speed, one or a plurality of the intermediate frames may be provided and the number of the coupling frames 11 may be increased to increase the strength of the propeller guard body 10.

The upper frame 13 is a frame provided on the uppermost surface of the propeller guard body 10.

The lower frame 14 is a frame provided below the upper frame 13 and substantially parallel to the upper frame 13. A motor 31 for the propeller 30 is mounted on the lower frame 14.

The base frame 15 is installed below the lower frame 14 (at the lowermost surface of the propeller guard body 10) substantially parallel to the upper frame 13, and is a frame to be in contact with an object such as the ground at the time of landing of the flight vehicle 1. The base frame 15 provides stability at the time of landing of the flight vehicle 1 and protects the bottom of the flight vehicle 1. Center points of the upper frame 13, the lower frame 14, and the base frame 15 are desirably located on a center axis of the flight vehicle body 20 to balance the flight vehicle during flight.

The coupling frame 11 is a frame that couples the upper frame 13, the lower frame 14, and the base frame 15 together. The coupling frame 11 includes a first coupling portion 112 that couples the upper frame 13 and the lower frame 14 together, and a second coupling portion 113 that couples the lower frame 14 and the base frame 15 together. In the example of FIG. 2, the upper frame 13, the lower frame 14, the base frame 15, and the coupling frame 11 constitute the propeller guard body 10 configured to surround the propellers 30 of the flight vehicle 1. The shape of the propeller guard body 10 illustrated in FIG. 2 is an example. In addition, for simplicity of explanation, in the following embodiment, as an example, the propeller guard body 10 has an outer edge that appears circular as viewed from vertically above. However, the propeller guard body 10 can have any shape.

The rod-shaped body 40 is provided on an upper portion of the propeller guard body 10 and includes a first end 44, a second end 41, an elastic member 42, and a rod-shaped main body 43. The first end 44 as one end of the rod-shaped body 40 is provided near a peripheral portion of an upper surface of the propeller guard body 10. The rod-shaped body 40 extends while passing above the upper surface, for example, near the center, of the propeller guard body 10 as viewed from vertically above. In the example of FIG. 2, the rod-shaped body 40 is attached to the upper frame 13 by the first end 44. The second end 41 of the rod-shaped body 40 is located outside the outer edge of the propeller guard body 10 as viewed from vertically above. In the example of FIG. 2, the rod-shaped body 40 includes the elastic member 42 having elastic force, such as a spring.

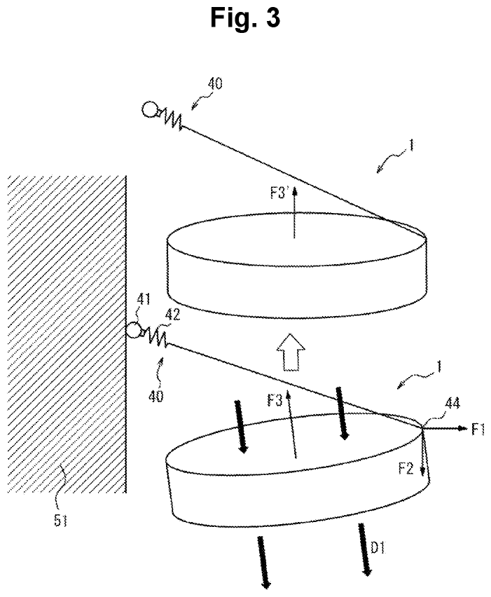

FIG. 3 illustrates a state in which the flight vehicle 1 including the propeller guard 2 according to the embodiment comes into contact with a wall surface during movement vertically upward. As illustrated in FIG. 3, it is assumed that when the flight vehicle 1 to which the propeller guard 2 is attached is caused to ascend in a structure 51, the flight vehicle 1 discharges air in a D1 direction and moves in an F3 direction, and the rod-shaped body 40 comes into contact with the wall surface or the like of the structure 51. In this case, force F1 for separating from the wall and force F2 for leveling the flight vehicle 1 are applied at the first end 44 that is a connection point between rod-shaped body 40 and the propeller guard body 10 of the flight vehicle 1. As described above, when an end of the rod-shaped body 40 comes into contact with the wall surface or the like of the structure 51, the force is transmitted to the farthest propeller guard body 10, so that rotation of the flight vehicle 1 with the second end 41 of the rod-shaped body 40 in contact as a fulcrum is suppressed. The flight vehicle 1 instantaneously moves away from structure 51 and changes its course in an F3′ direction. Thus, it is possible to prevent the flight vehicle 1 from rotating with a contact point between the propeller guard body 10 and the wall surface of the structure 51 as a fulcrum or the flight vehicle 1 from sticking to the wall surface of the structure 51. In addition, by providing the elastic member 42 at the end of the rod-shaped body 40 or the like, the rod-shaped body 40 exerts repulsive force outward from the propeller guard body 10 with respect to the wall. Thus, a time of contact between the wall surface of the structure 51 and the rod-shaped body 40 can be shortened, and the rotation of the flight vehicle 1 and the sticking to the wall surface can be further suppressed.

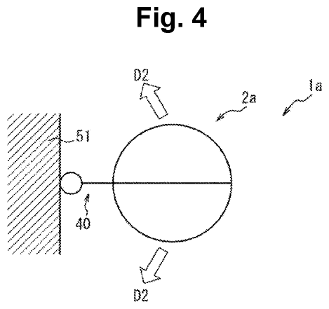

The propeller guard 2 according to the present embodiment can be configured by attaching any number of the rod-shaped bodies 40 to the propeller guard body 10. FIG. 4 is an example of a top view of a flight vehicle 1a including a propeller guard 2a including one rod-shaped body 40. In a case where a surface of the flight vehicle 1 that comes into contact with the wall surface of the structure 51 is limited, it is possible to prevent the flight vehicle 1a from rotating in the vertical direction with the contact point between the propeller guard body 10 and the wall surface of the structure 51 as a fulcrum or the flight vehicle 1 from sticking to the wall surface, even only by having one rod-shaped body 40. However, in a case where there is only one rod-shaped body 40, there is a possibility that rotation in a horizontal direction D2 occurs around the rod-shaped body 40 as an axis when the rod-shaped body 40 comes into contact with the wall surface of the structure 51.

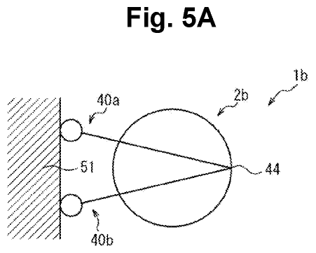

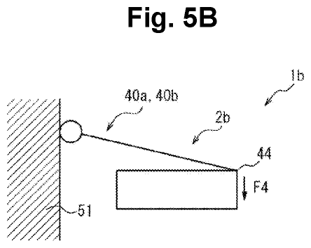

Thus, even in the case where the surface of the flight vehicle 1 that comes into contact with the wall surface of the structure 51 is limited, the flight vehicle 1 desirably has at least two rod-shaped bodies 40. FIG. 5A is an example of a top view of a flight vehicle 1b including a propeller guard 2b including two rod-shaped bodies. FIG. 5B is an example of a side view of the flight vehicle 1b including the propeller guard 2b including the two rod-shaped bodies. As illustrated in FIGS. 5A and 5B, the first end 44 of the rod-shaped body may be provided at a position farthest from the wall surface of the structure 51, and the rod-shaped body 40 may be connected to the propeller guard body 10 through the first end 44. As a result, force F4 for leveling the flight vehicle 1 increases, and it is possible to further prevent the flight vehicle 1 from rotating with the contact point between the propeller guard body 10 and the wall surface of the structure 51 as a fulcrum or the flight vehicle 1 from sticking to the wall surface of the structure 51.

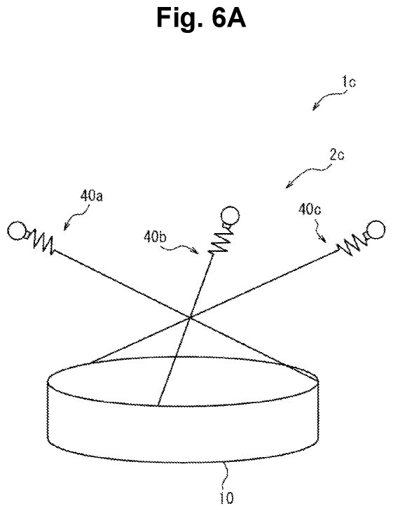

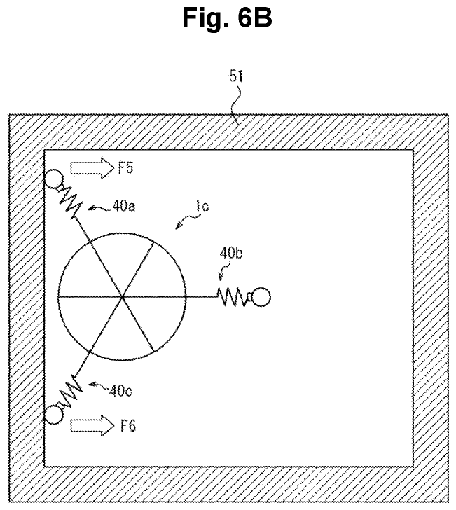

When the surface of the flight vehicle 1 that comes into contact with the wall surface of the structure 51 is not limited, it is desirable to provide three or more rod-shaped bodies 40. FIG. 6A is an example of a perspective view of a flight vehicle 1c including a propeller guard 2c including three rod-shaped bodies. FIG. 6B is an example of a top view of the flight vehicle 1c including the propeller guard 2c including the three rod-shaped bodies. As illustrated in FIGS. 6A and 6B, by arranging a plurality of rod-shaped bodies 40a, 40b, and 40c at equal intervals, it is possible to prevent the propeller guard body 10 or the flight vehicle body 20 from directly coming into contact with the wall surface even if the contact with the wall surface of the structure 51 occurs from any horizontal direction. That is, in a case where the rod-shaped bodies 40 come into contact with the wall surface as illustrated in FIG. 6B, repulsive forces F5 and F6 are caused to act through the rod-shaped bodies 40, whereby the flight vehicle 1c can be kept horizontal.

The second end 41 of the rod-shaped body 40 is located outside the outer edge of the propeller guard body 10 as viewed from vertically above. The length of the rod-shaped body 40 for implementing such a configuration will be described below. Hereinafter, for simplicity of explanation, an example will be described in a case where the propeller guard body 10 has a cylindrical shape.

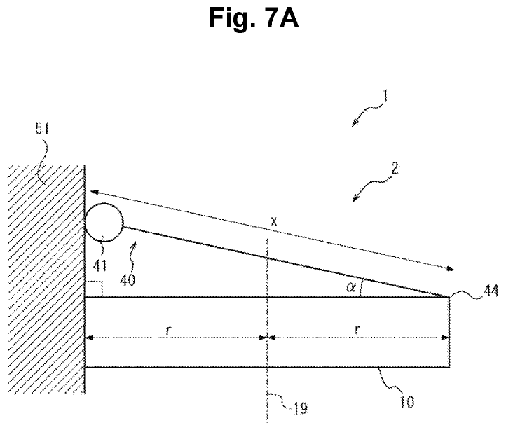

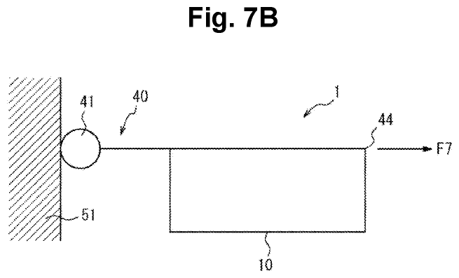

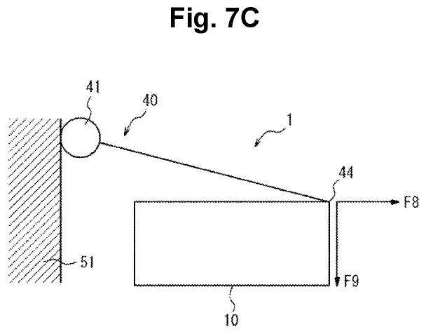

FIGS. 7A, 7B, and 7C are examples of side views of the flight vehicle 1 including the propeller guard 2 including one rod-shaped body 40. FIG. 7A corresponds to a cross section of the flight vehicle 1 in a vertical plane passing through the first end 44 and the second end 41 of the rod-shaped body 40. Here, for simplicity of explanation, a case will be described where the rod-shaped body 40 passes vertically above a center axis 19 of the propeller guard body 10.

As illustrated in FIG. 7A, an angle formed by the rod-shaped body 40 and the upper surface of the propeller guard body 10 at the first end 44 is defined as a, and a radius of a bottom surface of the propeller guard body 10 is defined as r. In this case, a condition of a length x of the rod-shaped body 40 required for the second end 41 of the rod-shaped body 40 to be located outside the outer edge of the propeller guard body 10 as viewed from vertically above is expressed by Expression (1).

X>2r/cos α (1)

In the case of α=0°, when the rod-shaped body 40 comes into contact with the wall surface or the like of the structure 51 as illustrated in FIG. 7B, only force F7 for separating the flight vehicle 1 from the wall acts. On the other hand, in the case of 0°<α<90°, that is, in a case where the second end 41 is above the first end 44, when the rod-shaped body 40 comes into contact with the wall surface or the like of the structure 51 as illustrated in FIG. 7B, force F8 for separating the flight vehicle 1 from the wall and force F9 for leveling the flight vehicle 1 can be caused to act.

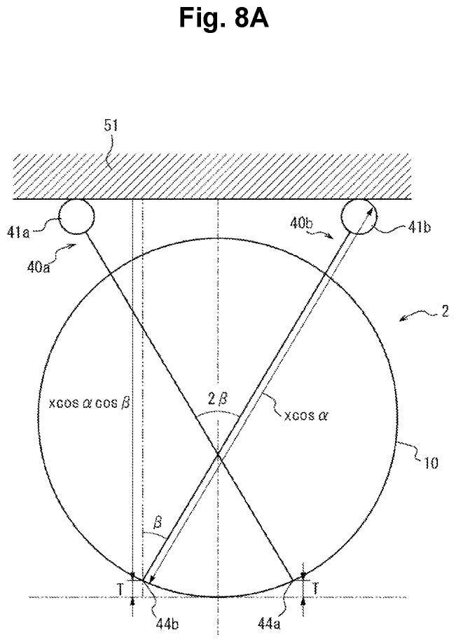

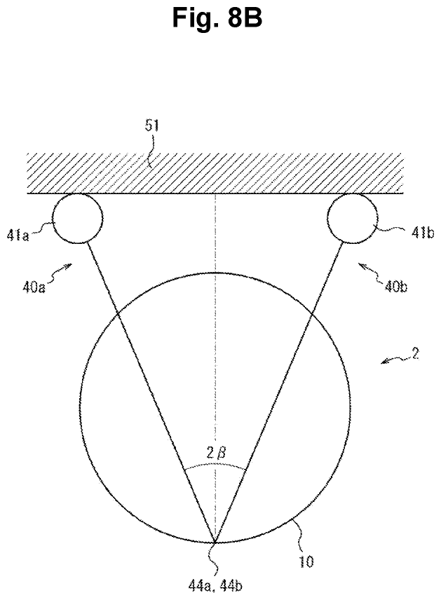

FIGS. 8A and 8B are examples of top views of the propeller guard 2 including two rod-shaped bodies 40a and 40b. FIG. 8A illustrates an example in a case where a first end 44a of the rod-shaped body 40a and a first end 44b of the rod-shaped body 40b are provided at different positions on the peripheral portion of the upper surface of the propeller guard body 10. Here, an example will be described in a case where lengths of the two rod-shaped bodies 40a and 40b are equal to each other.

An angle formed by the rod-shaped bodies 40a and 40b and the upper surface of the propeller guard body 10 at the first ends 44a and 44b is defined as a, a radius of the bottom surface of the propeller guard body 10 is defined as r, and an angle formed by the rod-shaped bodies 40a and 40b as viewed from vertically above is defined as β. Further, it is assumed that both second ends 41a and 41b are in contact with the vertical wall surface, and the propeller guard body 10 is kept horizontal. In this case, on a side where the first ends 44a and 44b are present, a distance between a vertical plane parallel to the wall surface and in contact with the propeller guard body 10 and the first ends 44a and 44b is defined as T. FIG. 8B illustrates an example in the case of T=0. In such a case, a condition of the length x of the rod-shaped bodies 40a and 40b required for the second ends 41a and 41b of the rod-shaped body 40 to be located outside the outer edge of the propeller guard body 10 as viewed from vertically above is expressed by Expression (2).

X>(2r−T)/x cos α cos β (2)

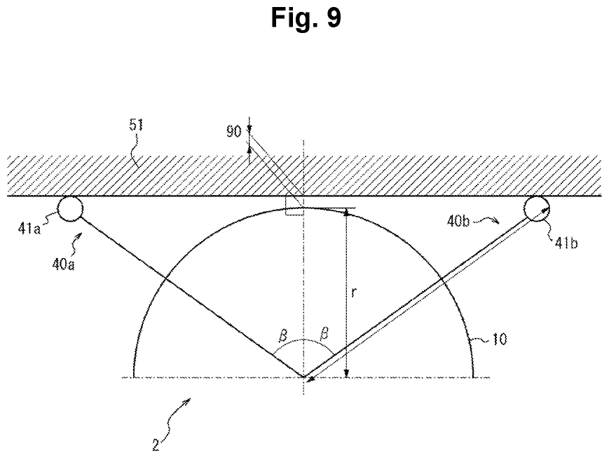

FIG. 9 is an example of a top view of the propeller guard 2 including three or more rod-shaped bodies. Hereinafter, an example will be described in a case where three or more rod-shaped bodies having the same length are provided at equal intervals. An angle formed by each rod-shaped body 40 and the upper surface of the propeller guard body 10 at the first end 44 is defined as a, a radius of the bottom surface of the propeller guard body 10 is defined as r, and an angle formed by the rod-shaped bodies 40a and 40b adjacent to each other as viewed from vertically above is defined as 2β. Since the rod-shaped bodies 40 are provided at equal intervals, the number n of the rod-shaped bodies 40 and β have a relationship of the following Expression (3).

β=180°/n (3)

In such a case, a condition of the length x of each rod-shaped body 40 required for the second end 41 of each rod-shaped body 40 to be located outside the outer edge of the propeller guard body 10 as viewed from vertically above is expressed by Expression (4).

x>(r+r cos β)/cos α cos β (4)

In a case where the condition of Expression (4) is satisfied, a first rod-shaped body and a second rod-shaped body that have the second ends adjacent to each other have lengths such that a vertical plane passing through the second end of the first rod-shaped body and the second end of the second rod-shaped body is located outside the outer edge of the propeller guard body 10. In a case where each rod-shaped body has such a length, as illustrated in FIG. 9, even if the second end 41a of the rod-shaped body 40a and the second end 41b of the rod-shaped body 40b provided adjacent to each other as viewed from vertically above come into contact with the structure 51, there is a gap 90 between the propeller guard body 10 and the structure 51. For that reason, even in a case where the flight vehicle 1 comes into contact with the wall surface or the like of the structure 51 from any direction when moving vertically upward, the rod-shaped body 40 comes into contact with the wall surface or the like of the structure 51 before the propeller guard body 10 comes into contact with the wall surface or the like of the structure 51. Thus it is possible to exert force for separating the flight vehicle 1 from the wall and force for leveling the flight vehicle 1, and it is possible to prevent the flight vehicle 1 from rotating with the contact point between the propeller guard body 10 and the wall surface of the structure 51 as a fulcrum or the flight vehicle 1 from sticking to the wall surface of the structure 51.

In addition, by making a part or the whole of the rod-shaped body 40 an elastic member, it is possible to shorten the time during which the rod-shaped body 40 comes into contact with the wall surface or the like of the structure 51 and to increase the force for separating the flight vehicle 1 from the wall and the force for leveling the flight vehicle 1. Thus, it is possible to further prevent the flight vehicle 1 from rotating with the contact point between the propeller guard body 10 and the wall surface of the structure 51 as a fulcrum or the flight vehicle 1 from sticking to the wall surface of the structure 51.

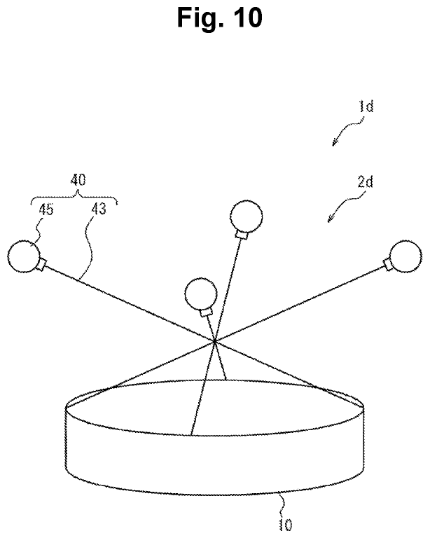

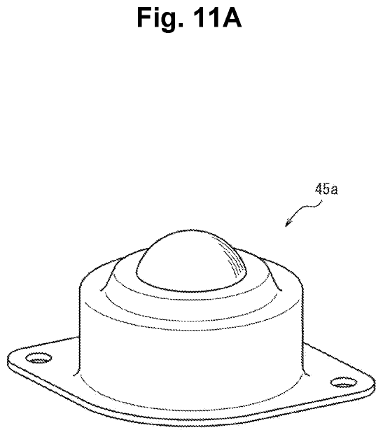

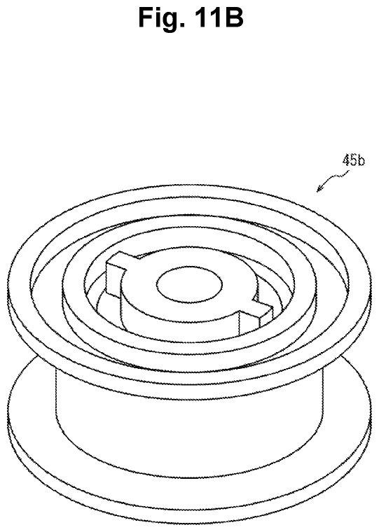

The propeller guard 2 may be provided with a rotating member at the second end 41 of the rod-shaped body 40. FIG. 10 is an example of a perspective view of a flight vehicle 1d including the propeller guard 2 including a rod-shaped body provided with a rotating member 45. As the rotating member 45, for example, a ball caster illustrated in FIG. 11A, a bearing roller illustrated in FIG. 11B, or the like can be used.

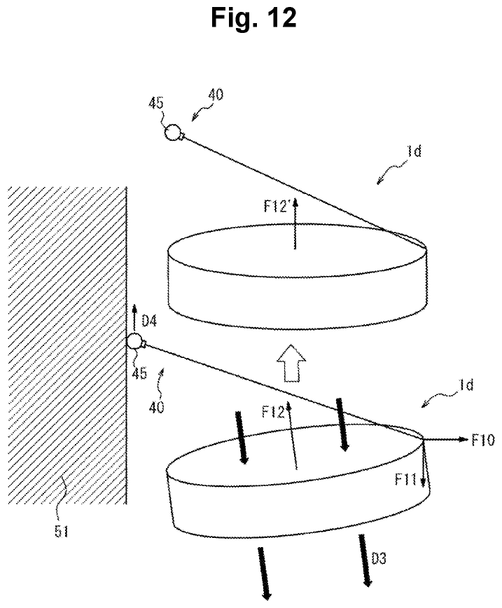

FIG. 12 illustrates a state in which the flight vehicle 1d including the rotating member 45 at the second end 41 of the rod-shaped body 40 comes into contact with the wall surface during movement vertically upward. As illustrated in FIG. 12, it is assumed that when the flight vehicle 1d to which the propeller guard body 10 is attached is caused to ascend in the structure 51, the flight vehicle 1 discharges air in a D3 direction and moves in an F12 direction, and the rotating member 45 of the rod-shaped body 40 comes into contact with the wall surface or the like of the structure 51. In this case, force F10 for separating from the wall and force F11 for leveling the flight vehicle 1d are applied at the first end 44 that is a connection point between the rod-shaped body 40 and the propeller guard body 10 of the flight vehicle 1d. Further, the rotating member 45 rotates at the contact point with the wall surface, so that frictional resistance with the wall surface can be reduced, and the rod-shaped body 40 can be made to be less likely to be caught by the wall surface. For example, the rotating member 45 can move in a vertically upward direction D4 while rotating. Thus, by providing the rotating member 45, it is possible to further prevent the flight vehicle 1 from sticking to the wall surface of the structure 51.

Note that, in the above description, an example has been described in which the propeller guard body 10 includes the rod-shaped body 40; however, the flight vehicle body 20 may include the rod-shaped body 40. As a result, according to a principle similar to that of the propeller guard 2 described above, it is possible to suppress occurrence of rotation of the flight vehicle body 20 due to contact with an object in a case where the rod-shaped body 40 comes into contact with the wall surface or the like of the structure 51. In addition, the rod-shaped body 40 may be provided as a component attachable to the flight vehicle body 20 or the propeller guard body 10, not in a state of being attached to the flight vehicle body 20 or the propeller guard body 10.

### REFERENCE SIGNS LIST

1 flight vehicle
2 propeller guard
10 propeller guard body
11 coupling frame
13 upper frame
14 lower frame
15 base frame
20 flight vehicle body
30 propeller
31 motor
40 rod-shaped body
41 second end
42 elastic member
43 rod-shaped main body
44 first end
45 rotating member
50 manhole
51 structure
52 step
53 manhole lid receiving frame
112 first coupling portion
113 second coupling portion

1. A propeller guard comprising:
a propeller guard body configured to surround a propeller of a flight vehicle; and
a rod-shaped body provided on an upper portion of the propeller guard body and including a first end and a second end,
wherein
the first end of the rod-shaped body is provided near a peripheral portion of an upper surface of the propeller guard body, and
the rod-shaped body extends while passing above the upper surface of the propeller guard body as viewed from vertically above.

2. The propeller guard according to claim 1, wherein the second end of the rod-shaped body is located outside an outer edge of the propeller guard body as viewed from vertically above.

3. The propeller guard according to claim 1, comprising a plurality of rod-shaped bodies.

4. The propeller guard according to claim 3, wherein a first one of the plurality of rod-shaped bodies and a second one of the plurality of rod-shaped bodies that have the second ends adjacent to each other have lengths such that a vertical plane passing through the second end of the first one of the plurality of rod-shaped bodies and the second end of the second one of the plurality of rod-shaped bodies is located outside the outer edge of the propeller guard body.

5. The propeller guard according to claim 1, wherein a part or all of the rod-shaped body is an elastic member.

6. The propeller guard according to claim 1, wherein the second end of the rod-shaped body is provided with a rotating member.

7. A flight vehicle comprising
a rod-shaped body provided on an upper portion of the flight vehicle,
wherein
one end of the rod-shaped body is provided near a peripheral portion of an upper surface of the flight vehicle, and
the rod-shaped body extends while passing above the upper surface of the flight vehicle as viewed from vertically above.

8. A rod-shaped body comprising one end attached near a peripheral portion of an upper surface of a flight vehicle or an upper surface of a propeller guard body configured to surround a propeller of the flight vehicle such that the rod-shaped body extends while passing above the upper surface of the flight vehicle as viewed from vertically above.

9. The propeller guard according to claim 2, comprising a plurality of rod-shaped bodies.

10. The propeller guard according to claim 2, wherein a part or all of the rod-shaped body is an elastic member.

11. The propeller guard according to claim 2, wherein the second end of the rod-shaped body is provided with a rotating member.

12. The flight vehicle according to claim 7, further comprising:
a propeller guard body configured to surround a propeller of the flight vehicle.

13. The flight vehicle according to claim 12, wherein the second end of the rod-shaped body is located outside an outer edge of the propeller guard body as viewed from vertically above.

14. The flight vehicle according to claim 12, comprising a plurality of rod-shaped bodies.

15. The flight vehicle according to claim 14, wherein a first one of the plurality of rod-shaped bodies and a second one of the plurality of rod-shaped bodies that have the second ends adjacent to each other have lengths such that a vertical plane passing through the second end of the first one of the plurality of rod-shaped bodies and the second end of the second one of the plurality of rod-shaped bodies is located outside the outer edge of the propeller guard body.

16. The flight vehicle according to claim 12, wherein a part or all of the rod-shaped body is an elastic member.

17. The flight vehicle according to claim 12, wherein the second end of the rod-shaped body is provided with a rotating member.

18. The rod-shaped body according to claim 8, wherein the second end of the rod-shaped body is located outside an outer edge of the propeller guard body as viewed from vertically above, and wherein the propeller guard body is configured to surround a propeller of the flight vehicle.

19. The rod-shaped body according to claim 8, comprising a plurality of rod-shaped bodies.

20. The rod-shaped body according to claim 19, wherein a first one of the plurality of rod-shaped bodies and a second one of the plurality of rod-shaped bodies that have the second ends adjacent to each other have lengths such that a vertical plane passing through the second end of the first one of the plurality of rod-shaped bodies and the second end of the second one of the plurality of rod-shaped bodies is located outside the outer edge of the propeller guard body.
